(19) United States
(12) Patent Application Publication
(10) Pub. No.: US 2014/0255807 A1
(43) Pub. Date: Sep. 11, 2014

(54) DIRECT METHANOL FUEL CELL OPERABLE WITH NEAT METHANOL

(71) Applicant: California Institute of Technology, Pasadena, CA (US)

(72) Inventors: Sekharipuram R. Narayanan, Arcadia, CA (US); Andrew Kindler, San Marino, CA (US); Thomas I. Valdez, Covina, CA (US)

(73) Assignee: California Institute of Technology, Pasadena, CA (US)

(21) Appl. No.: 14/282,190

(22) Filed: May 20, 2014

Related U.S. Application Data
(63) Continuation of application No. 12/008,106, filed on Jan. 8, 2008.
(60) Provisional application No. 60/879,257, filed on Jan. 8, 2007.

(51) Int. Cl. H01M 8/04; H01M 8/06

(52) U.S. Cl. CPC H01M 8/04291; H01M 8/04007; H01M 8/0612
USPC 429/416; 429/450; 429/434

(57) ABSTRACT

A fuel cell system running on direct neat methanol. Back diffusion of water from the cathode to the anode is sufficiently high so that water is not accumulated at the cathode, thereby leading to fuel cell systems without the need for a pump system to remove circulate water from the cathode to the anode. Other embodiments are described and claimed.

### PRIORITY CLAIM

This application is a continuation of U.S. patent application Ser. No. 12/008,106 filed Jan. 8, 2008, which claimed the benefit of U.S. Provisional Application No. 60/879,257, filed 8 Jan. 2007.

### GOVERNMENT INTEREST

The claimed invention was made in the performance of work under a NASA contract, and is subject to the provisions of Public Law 96-517 (35 USC 202) in which the Contractor has elected to retain.

### FIELD

The present invention relates to fuel cells.

### BACKGROUND

FIG. 1 illustrates a high-level system diagram of a prior art direct methanol fuel cell operating on an aqueous feed of methanol. Neat (100%) methanol is stored in container 102 and then diluted with water to a concentration of 2-3% before it is introduced into fuel cell stack 104. The methanol fuel solution is re-circulated, indicated by the loop comprising flow line 106, gas and liquid separator 108, radiator 110 and bypass 112, pump 114, mixer 116, methanol sensor 118, and cold-start heater 120. Methanol is added to the solution by way of pump 114 and mixer 116 as needed to maintain the required concentration delivered to anode 122. The fuel solution entering anode 122 is accurately monitored and controlled using methanol sensor 118.

The water used for this dilution is gathered at cathode 124, flows through flow line 126 to sump tank 128, and is pumped by sump pump 130 to gas and liquid separator 108. Carbon dioxide is generated at and removed from anode 122, as indicated by flow line 132.

Diluting methanol, collecting and circulating water, circulating fuel, and controlling concentration entail the use of several pumps and control systems, with their resulting use of electrical energy, and add to the size and cost of the fuel cell system. These auxiliary components may constitute about 50% of the overall volume and mass of present state-of-art direct methanol fuel cell systems, and may contribute to at least 50% of the parasitic energy consumption.

### BRIEF DESCRIPTION OF THE DRAWINGS

FIG. 1 illustrates a prior art fuel cell system.

FIG. 2 illustrates a fuel cell according to an embodiment.

FIG. 3 illustrates a fuel cell system according to an embodiment.

FIG. 4 illustrates dependence of current density upon membrane thickness for an embodiment.

FIG. 5 illustrates an anode electrode according to an embodiment.

### DESCRIPTION OF EMBODIMENTS

In the description that follows, the scope of the term “some embodiments” is not to be so limited as to mean more than one embodiment, but rather, the scope may include one embodiment, more than one embodiment, or perhaps all embodiments.

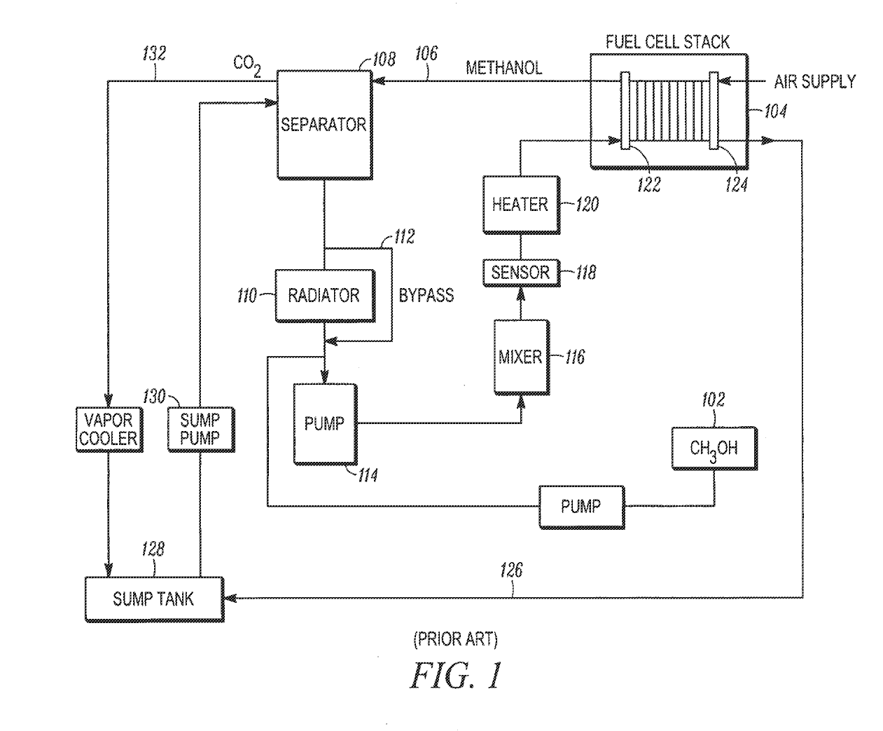

These letters patent teach the design of a direct methanol fuel cell in which back diffusion of water from the cathode to the anode in a methanol fuel stack is high enough so that water need not be collected at the cathode, and neat methanol may be provided to the anode without the need for dilution. By not requiring the gathering of water at the cathode, or the dilution of neat methanol, it is expected that embodiments may have reduced parasitic energy losses, higher power density, and higher reliability at reduced cost, compared to the prior art direct methanol fuel cell system of FIG. 1.

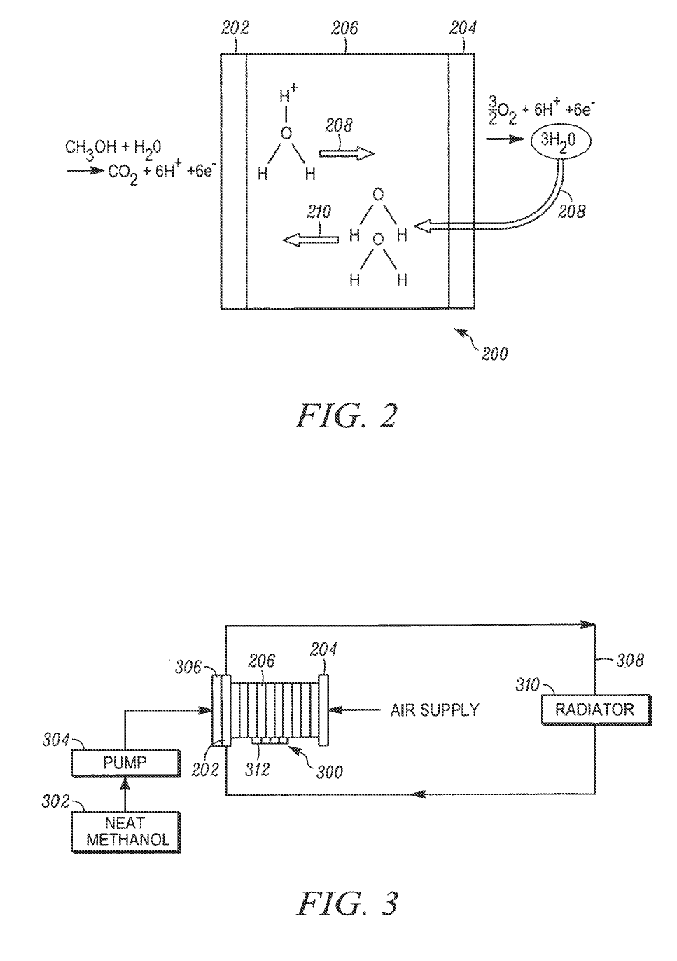

FIG. 2 illustrates an embodiment fuel cell 200, and some of the processes involved. During fuel cell operation neat methanol (CH₃OH) is oxidized at anode 202 to protons and carbon dioxide, and oxygen (0₂) is reduced to water at cathode 204. As protons migrate from anode 202 to cathode 204 by way of membrane 206, water is transported with the protons (H⁺), as indicated by arrow 208. This process is termed electro-osmotic drag, in which water molecules associated with the protons are dragged across membrane 206 in the direction of ionic movement.

Water is consumed at anode 202 by the oxidation of methanol, and water is produced at cathode 204 by reduction of oxygen. Air flowing across cathode 204 evaporates some of this water. The remaining water generated at cathode 204, as well as the water arriving at cathode 204 due to electro-osmotic drag, is brought to anode 202 by to back diffusion, as indicated by arrows 208 and 210.

It is useful to understand the factors that govern the rates of various water transport processes. The rate of consumption of water at anode 202 is determined by the current density, and for some embodiments, one mole of water is consumed for every 6 Faradays of electricity. The rate of migration of water from anode 202 to cathode 204 by electro-osmotic drag is determined by the current density and the drag coefficient. The some embodiments, the drag coefficient is about 3 molecules of water per proton. The rate of production of water at cathode 204 by reduction is also determined by the current density, and for some embodiments is given by 0.5 mole of water for every Faraday of electricity.

The flow rate of air over cathode 204, the temperature of fuel cell 200, and the absolute humidity of air at the specified temperature determine the rate of evaporative loss. The concentration gradient of water between anode 202 and cathode 204, and the diffusion coefficient of water in the membrane-electrode composite (206) determine the rate of back-diffusion. Accordingly, the rate of back diffusion may be increased by increasing the concentration gradient for water, and this process may be relatively independent of the current density.

Thus, the rate of back diffusion to move water from cathode 204 to anode 202 that has not been removed due to evaporation may be achieved by appropriately choosing the concentration of methanol, the porosity of the electrodes in anode 202 and cathode 204, the thickness of membrane 206, the operating temperature of fuel cell 200, and the stoichiometric rate of airflow over cathode 204. For any given set of conditions for the foregoing variables, there will be a current density at which water balance will be achieved. Water balance means that the back diffusion rate and evaporative rate at cathode 204 are such that water does not accumulate at cathode 204.

Calculations have shown that when about 1 molar (3%) methanol solutions are circulated past anode 202, the rate of back diffusion is inadequate to transport the water for a practical value of current density, and the current density at which water balance is achieved is quite low to be of practical value for most applications. However, when neat (100%) methanol is used, the back diffusion process alone is expected to achieve the water balance at a current density of 170 mA/cm² (mill-Ampere per square cm). This latter value of current density is expected to be in the range useful for practical applications.

More specifically, calculations show that for a membrane thickness of 0.0635 cm, a stoic rate for air flow over cathode 204 of 3.0, a drag coefficient of 3.0 water molecules for each proton (H⁺) transported by electro-osmotic drag, a temperature of 45° C., and a diffusion coefficient for water of 8.16*10⁻⁶ cm²/sec; water balance is achieved for a methanol concentration of 3% at a current density of only 7 mA/cm², but water balance is achieved using neat methanol according to an embodiment at a useful current density of 170 mA/cm².

Thus, the above description teaches that by using neat methanol and designing the fuel cell such that water is returned to the anode by back diffusion from the cathode, a practical current density may be achieved, and mechanical means for collecting and returning water may be avoided. FIG. 3 illustrates an embodiment, where neat methanol stored in container 302 is pumped by pump 304 to delivery system 306. Delivery system 306 provides neat methanol directly to anode 202, and fuel cell 300 is designed so that the back diffusion of water is sufficient so that water need not be removed at cathode 204, other than by evaporation. An embodiment for delivery system 306 is described later.

For some embodiments, membrane 206 may comprise Nafion. Nafion is a sulfonated tetrafluorethylene copolymer, and is a registered trademark of E. I. Du Pont de Nemours and Company, a corporation of Delaware. For such embodiments, membrane 206 is hydrophilic, and may for some embodiments allow water retention of up to about 40% of the membrane mass. Also, for some embodiments, water and carbon dioxide is produced by direct reaction of methanol with oxygen at anode 306 or cathode 204, so that an adequate supply of water may be produced.

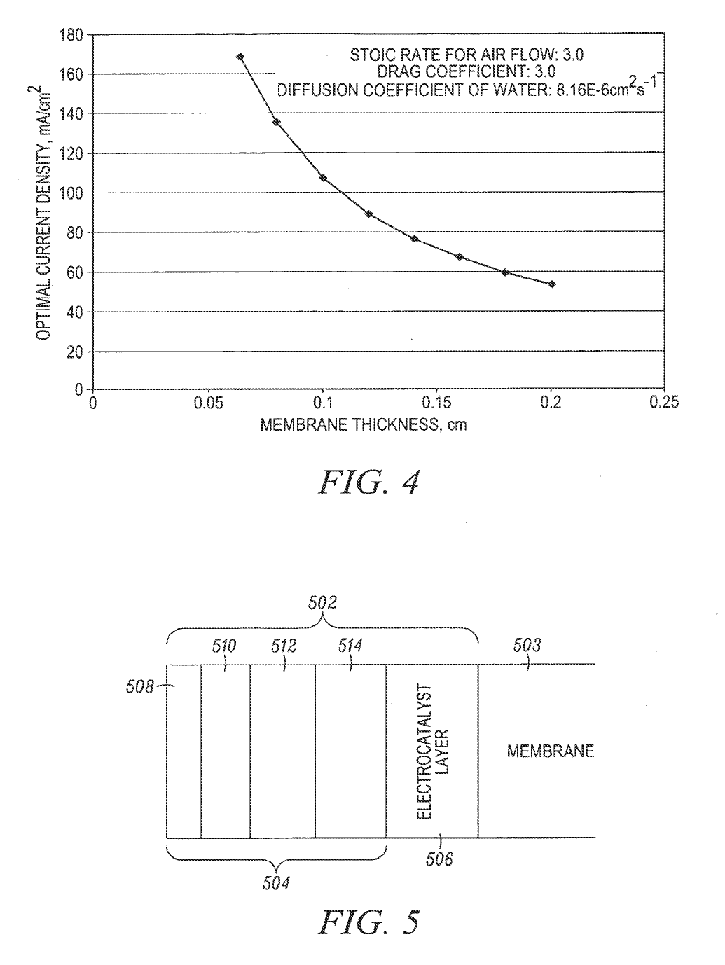

If anode 202, cathode 204, or both are not capable of sustaining desired current densities due to slow catalysis or mass transport of reactants, then the electrode structures for anode 202 or cathode 204, and the thickness of membrane 206, may be adjusted so that an acceptable current density value may be achieved. An example is illustrated by FIG. 4.

FIG. 4 illustrates a functional relationship between fuel cell current density (mA/cm²) and membrane thickness (cm) for the following fuel cell parameters: a stoic air flow rate of 3.0; a drag coefficient of 3.0 water molecules per proton; and a diffusion coefficient for water of 8.16×10⁻⁶ cm²/sec. As noted in FIG. 4, reducing the membrane thickness may lead to an increase in current density. For example, whereas a membrane thickness of 0.2 cm provides for a current density of about 46 mA/cm², reducing the membrane thickness to 0.06 cm provides for a current density of about 170 mA/cm².

The presence of an uncontrolled excess of neat methanol at anode 202 may result in swelling of membrane 206, which may lead to permanent damage of the membrane-electrode assembly. Accordingly, for some embodiments, the delivery rate of methanol to anode 202 should be such that only a relatively small quantity of methanol reaches the anode electrode. Furthermore, for some embodiments, the entire quantity of neat methanol that is delivered to the anode electrode should be utilized within the electrode structure, but the neat methanol should not reach the surface of membrane 206 in any significant quantity.

Full utilization of neat methanol at the anode electrode may be achieved if the electrode structure is modified to be porous and thick, so that the residence time for methanol is adequate for complete consumption in the body of the electrode structure.

For some embodiments, such a porous electrode should have enough ionomer material to form conducting paths for the protons and water, but have the enough tortousity to assure a high residence time.

An ionomer is a polyelectrolyte comprising copolymers. For some embodiments, the electrode structure may have layers of varying ionomer content so that the desired level of utilization may be achieved. The thickness, layer design, and porosity of the electrodes may depend on the delivery rate. FIG. 5 illustrates in a simplified pictorial form anode electrode 502 and membrane 503. Anode electrode 502 comprises carbonaceous substrate 504 and electrocatalyst layer 506. lonomer material is impregnated into carbonaceous substrate 504 to form varying layers of ionomer material 508, 510, 512, and 514.

For some embodiments, the optimization of the electrode structure should be done in conjunction with the delivery method for the neat methanol. For some embodiments, delivery system 306 for delivering the neat methanol to anode 202 may be an aerosol delivery system as described in U.S. Pat. No. 6,440,594. As another example, for some embodiments, delivery system 306 may include a diffusion barrier of sufficient thickness.

For some embodiments, the use of neat methanol at anode 202 and a back diffusion that provides water balance may involve the use of a modified fuel cell stack design that incorporates methods not only for fuel delivery but also for heat removal. For some embodiments, circulating feed 308 may be used, so that excess heat may be removed from anode 202 by way of radiator 310. Heat may also be removed by evaporative cooling on cathode 204. For some embodiments without circulating feed 308, heat loss due to evaporation at cathode 204 may be augmented with heat removal by way of cooling fins 312 on the fuel stack. The design of such fins may depend on the power level and other resources available for cooling.

Various modifications may be made to the described embodiments without departing from the scope of the invention as claimed below.

What is claimed is:

1. A method of operating a fuel cell comprising:
providing an anode and a cathode electrode in fluid communication via a membrane disposed therebetween;
exposing the anode electrode to a source of methanol, such that the methanol is oxidized at the anode to produce protons, carbon dioxide, and oxygen;
exposing the cathode electrode to a source of air, such that the cathode reduces the oxygen from the anode to produce water, and wherein the cathode electrode evaporates water at a characteristic water evaporation rate;
wherein the membrane disposed between the anode electrode and the cathode electrode has a water migration rate that characterizes the flow of water molecules from the anode electrode to the cathode electrode resulting from electro-osmotic drag, and having a back diffusion rate that characterizes the flow of water molecules from the cathode electrode to the anode electrode;
configuring the membrane fuel cell operating conditions such that during operation the water migration rate is substantially equal to the sum of the back diffusion rate and the water evaporation rate such that all the water circulating within the fuel cell is produced at the cathode electrode from the reaction of the methanol at the anode electrode.

2. The method as set forth in claim 1, further comprising cooling the fuel cell.

3. The method as set forth in claim 2, wherein the cooling comprises the use of one of either a circulating radiator or evaporative cooling.

4. The method as set forth in claim 1, further comprising generating an aerosol of methanol for provision to the anode electrode.

5. The method as set forth in claim 1, further comprising providing a diffusion barrier through which said methanol flows to reach the anode electrode.

6. The method as set forth in claim 1, further comprising impregnating the anode electrode with ionomer material to provide varying layers of ionomer material.

7. The method as set forth in claim 1, wherein the membrane is hydrophilic.

8. The method as set forth in claim 1, wherein the membrane is capable of retaining water up to a concentration of about 40% of the membrane mass during operation.

9. The method as set forth in claim 1, further comprising configuring the membrane thickness to provide sufficient current density in said fuel cell.

10. The method as set forth in claim 1, wherein the fuel cell is operated at a current density of 170 mA/cm².

11. The method as set forth in claim 1, wherein the membrane is formed from a sulfonated tetrafluorethylene copolymer.

12. A method of operating a fuel cell having an anode electrode and a cathode electrode in fluid communication via an interposing membrane comprising configuring the fuel cell such that a water migration rate that characterizes the flow of water molecules from the anode electrode to the cathode electrode resulting from electro-osmotic drag is substantially equal to the sum of a back diffusion rate that characterizes the flow of water molecules from the cathode electrode to the anode electrode and a water evaporation rate at the cathode electrode.

13. The method of claim 12, wherein all the water circulating within the fuel cell is produced at the cathode from the reaction of methanol at the anode electrode.

14. The method as set forth in claim 12, further comprising cooling the fuel cell.

15. The method as set forth in claim 12, further comprising generating an aerosol of methanol for provision to the anode electrode.

16. The method as set forth in claim 12, further comprising providing a diffusion barrier through which said methanol flows to reach the anode electrode.

17. The method as set forth in claim 12, further comprising impregnating the anode electrode with ionomer material to provide varying layers of ionomer material.

18. The method as set forth in claim 12, wherein the membrane is hydrophilic.

19. The method as set forth in claim 12, wherein the membrane is capable of retaining water up to a concentration of about 40% of the membrane mass during operation.

20. The method as set forth in claim 12, further comprising configuring the membrane thickness to provide sufficient current density in said fuel cell.
